(19) United States
(12) Patent Application Publication
(10) Pub. No.: US 2025/0131446 A1
(43) Pub. Date: Apr. 24, 2025

(54) SYSTEMS AND METHODS FOR DIGITAL PRODUCT REIMBURSEMENT MANAGEMENT

(71) Applicant: Wells Fargo Bank, N.A., San Francisco, CA (US)

(72) Inventors: Blair Bijou, New York, NY (US); William J. Bailey, Charlotte, NC (US); Carrie Anne Hanson, Charlotte, NC (US); David Price, Kennewick, WA (US)

(21) Appl. No.: 18/491,331

(22) Filed: Oct. 20, 2023

(51) Int. Cl. G06Q 20/40; G06Q 20/32

(52) U.S. Cl. CPC G06Q 20/407; G06Q 20/3223; G06Q 20/3267

(57) ABSTRACT

Systems, apparatuses, methods, and computer program products are disclosed for digital product reimbursement management. An example method includes assigning a pending return status indicator to a transactional data record of a mobile banking application, the transactional data record being associated with a user. The example method also includes obtaining a first dataset associated with the user. The example method also includes determining that the first dataset corresponds to the transactional data record. The example method also includes reconciling the transactional data record based at least on the first dataset.

### BACKGROUND

A consumer may purchase a product with genuine intent but later decide to return or exchange the product for various reasons. In the modern world of online shopping, returns are a vital aspect of the consumer experience due to the inability to physically examine products before purchase.

### BRIEF SUMMARY

Refund, return, and/or exchange policies can differ significantly between merchants. For example, return windows, restocking fees, refund types (e.g., cash or store credit), return shipping costs, original packaging requirements, clearance item policies, and the like can vary among merchants. Due to the high degree of variability in these policies, it may be difficult for a consumer to keep track of where, when, and how best to return products which they have purchased.

It is also common for consumers to make purchases with the intent of returning one or more of the purchased items. For example, a consumer may purchase three pairs of the same clothing item in different sizes for a growing child, with the intention of keeping one and returning the other two which do not fit. However, it can be challenging for the consumer to keep track of whether returns are properly processed, especially when performed online. For instance, due to the delay introduced by shipping products back to a merchant, consumers may worry about the status of their returns, whether they were received by the merchant and when they should expect a refund.

Traditionally, it has been very difficult to monitor returns and exchanges and whether appropriate refunds have been issued, especially in cases in which a consumer purchases and returns products in bulk or otherwise at a high rate. Managing returns and exchanges can consume a significant amount of time and effort, impacting the convenience of online shopping. In addition, a consumer often needs to utilize multiple digital applications in order to manage returns, which monopolizes computational resources and processing capabilities of their personal user device. For instance, a consumer may juggle between a mobile banking application (e.g., to check if a refund was issued to their account), an email application (e.g., to check if communications from a merchant were received), a notes application (e.g., to manually create and continuously update lists of products which they have returned or intend to return), a third-party merchant application (e.g., to initiate a return and/or inquire about a return), and/or other applications on their personal user device. Further, managing returns via third-party merchant applications often requires consumers to create accounts and share sensitive information with merchants (e.g., financial data such as account numbers, credit card information, personal identifiable information (PII), and the like) which leaves consumers vulnerable to having their personal information compromised in the event that a merchant is impacted by a data breach.

In contrast to these conventional techniques for managing product returns and refunds, example embodiments described herein provide intelligent and efficient digital product reimbursement management facilitated centrally through a secure mobile banking application. As described herein, in some embodiments, a mobile banking application may flag (e.g., automatically or through user input) selected purchases for returns based on a transactional data record (e.g., data associated with a line item transaction within the mobile banking application). By flagging purchases, visual indicators may be applied to assist a consumer with tracking purchases which they may return. In some embodiments, the mobile banking application may automatically retrieve and present return policy information, e.g., based on a merchant indicated in the line item.

In some embodiments, notifications related to the return policy for a purchased item may be generated and pushed, e.g., via the mobile banking application, to the user. For example, a user may automatically receive a notification based on a return window for a flagged purchase expiring in one week. In some embodiments, the mobile banking application may enable a consumer to configure settings for item flagging or notifications related to returns. In some embodiments, after flagging a purchase as a potential return, the mobile banking application (or user) may update the transactional data record in response to determining the item has actually been returned. In response, the mobile banking application may monitor account(s) for the corresponding credit relating to the particular purchase and notify the consumer in the event a credit is received or in the event a credit has not been received within a certain period of time. In some embodiments, when a credit has been received for a return, the mobile application may automatically reconcile the corresponding flagged transactional data record, thereby allowing consumers to keep track of when and whether they have actually received the refunds for their various returns.

Additionally, in some embodiments, the mobile banking application may leverage GPS positioning of a user's device to identify that a user is present within a merchant location for which they have a return to make. In some embodiments, the mobile banking application may push a notification reminding the user of the item to be returned. In some embodiments, the mobile banking application may also keep a log of accumulated store credit from multiple returns and send reminders when store credit is nearing expiration.

Accordingly, the present disclosure sets forth systems, methods, and apparatuses that provide intelligent and efficient digital product reimbursement management facilitated centrally through a secure mobile banking application. There are many advantages of these and other embodiments described herein. For instance, returns and refunds may be tracked more efficiently through a centralized location (e.g., a mobile banking application), reducing the administrative burden that would otherwise be placed on an individual when attempting to track returns and refunds originating from a plurality of different merchants. In addition, embodiments minimize the risk of human error in recording return and refund data, leading to more accurate and reliable records. Additionally, users can check the status of their returns and refunds in real-time, reducing the need for customer support inquiries and enhancing transparency. Finally, embodiments described herein integrate refund and return tracking into a mobile banking application itself, expanding the potential user base significantly, and allowing use of refund tracking processes even for those without pre-existing detailed awareness of their financial transactions, and without the possibility for third-party data breaches related to transaction data.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for digital product management.

FIG. 2A illustrates a schematic block diagram of example circuitry embodying a system device of a digital product reimbursement management (DPRM) system that may perform various operations in accordance with some example embodiments described herein.

FIG. 2B illustrates a schematic block diagram of example circuitry embodying a user device and/or a device associated with a remote data source that may perform various operations in accordance with some example embodiments described herein.

FIG. 3 illustrates an example flowchart for digital product reimbursement management, in accordance with some example embodiments described herein.

FIG. 4 illustrates an example flowchart for using a model to determine whether to assign a pending return status indicator to a transactional data record, in accordance with some example embodiments described herein.

FIG. 5 illustrates an example flowchart for determining return policy information, in accordance with some example embodiments described herein.

FIG. 6 illustrates an example flowchart for generating and causing presentation of reminder data, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “mobile banking application” refers to a digital platform developed by one or more financial institutions that allows users to manage their financial activities and accounts conveniently through their personal user devices (e.g., smartphones, tablets, etc.). A mobile banking application combines a range of features to provide users with seamless access to banking services at any time. Through a mobile banking application, a user may perform various tasks, including (but not limited to) account management (e.g., viewing real-time account balances, line item transactions, transaction histories, and other information about their accounts), fund transfers, bill payments (e.g., including scheduling one-time or recurring payments), mobile check deposits (e.g., the mobile banking application may provide the capability to deposit checks by taking photos of the checks using the user device's camera), budgeting, investment management (e.g., monitor investment portfolios and execute stock trades), card management (e.g., freeze or unfreeze debit and/or credit cards and set spending limits), loan and credit applications, customer support (e.g., live chat or messaging with a customer service representative), currency conversion, virtual assistant interaction (e.g., chatbot or artificial intelligent (AI) assistant messaging), and the like. A mobile banking application also provides enhanced security features. For instance, a mobile banking application may incorporate multiple security layers, including biometric authentication (e.g., facial recognition and/or fingerprint recognition), Personal Identification Numbers (PINs), and encryption to ensure the protection of sensitive financial data (e.g., sensitive electronic files).

In various embodiments, a mobile banking application may interact with a server (e.g., digital product reimbursement management (DPRM) system 102) to provide data to users via the mobile banking application. For instance, when a user performs an action within the mobile banking application, the mobile banking application may generate and send a request to the server (e.g., DPRM system 102) that includes information about the specific action and may also include any authentication credentials of the user necessary for security. The server (e.g., DPRM system 102) may then process the request and retrieve any requested data or perform requested actions. In response, the server may format certain data (e.g., retrieved data) into a structured format (e.g., JavaScript Object Notation (JSON), Extensible Markup Language (XML), and/or the like) which can be interpreted by the mobile banking application, provide the structured data to the mobile banking application which may then be displayed (e.g., via client-side processing) in a user-friendly format on an interface of the mobile banking application. In various embodiments, encryption may be used to secure data transmissions between the mobile banking application (e.g., installed on a user device) and the server (e.g., the DPRM system 102).

### System Architecture

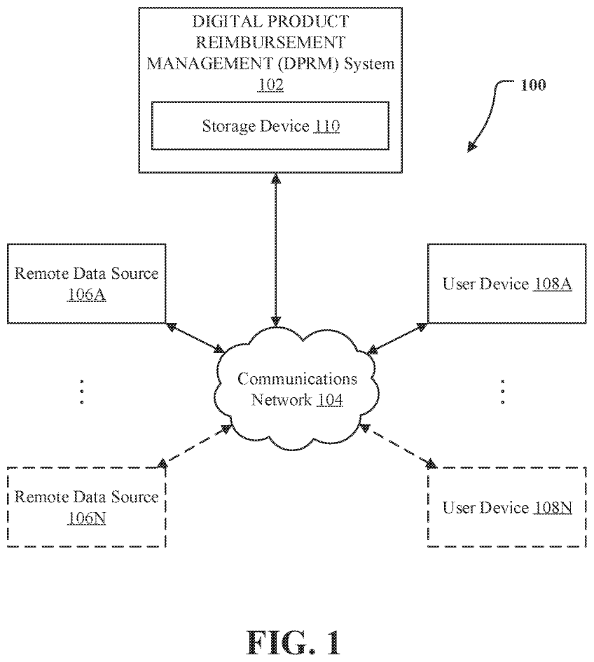

Example embodiments described herein may be implemented using any of a variety of computing devices or servers. To this end, FIG. 1 illustrates an example environment 100 within which various embodiments may operate. As illustrated, a digital product reimbursement management (DPRM) system 102 may receive and/or transmit information via communications network 104 (e.g., the Internet) with any number of other devices, such as one or more of remote data sources 106A-106N and/or user devices 108A-108N.

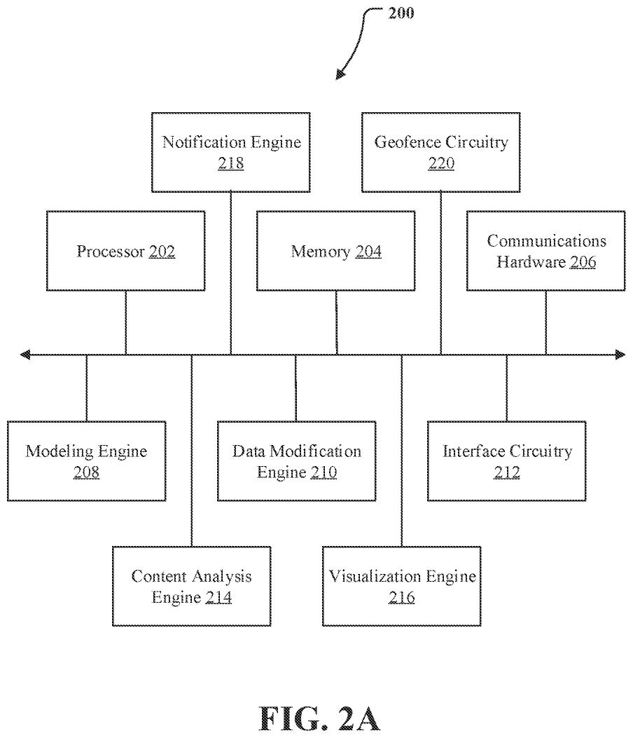

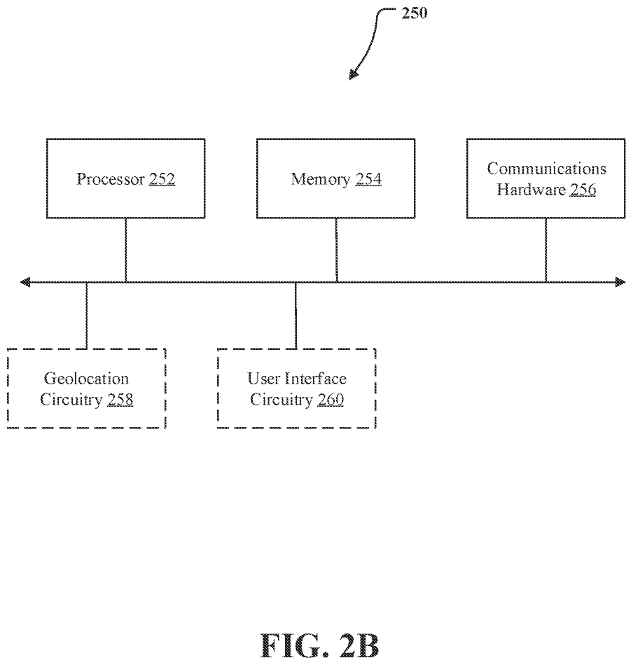

The DPRM system 102 may be implemented as one or more computing devices or servers, which may be composed of a series of components. Particular components of the DPRM system 102 are described in greater detail below with reference to apparatus 200 in connection with FIG. 2A.

In some embodiments, the DPRM system 102 further includes a storage device 110 that comprises a distinct component from other components of the DPRM system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the DPRM system 102. Storage device 110 may store information relied upon during operation of the DPRM system 102, such as various machine learning (ML) models that may be used by the DPRM system 102, datasets and documents to be analyzed using the DPRM system 102, or the like. In addition, storage device 110 may store control signals, device characteristics, and access credentials enabling interaction between the DPRM system 102 and one or more of the remote data sources 106A-106N or user devices 108A-108N.

The one or more remote data sources 106A-106N and the one or more user devices 108A-108N may be embodied by any computing devices known in the art. The one or more remote data sources 106A-106N and the one or more user devices 108A-108N need not themselves be independent devices, but may be peripheral devices communicatively coupled to other computing devices.

### Example Implementing Apparatuses

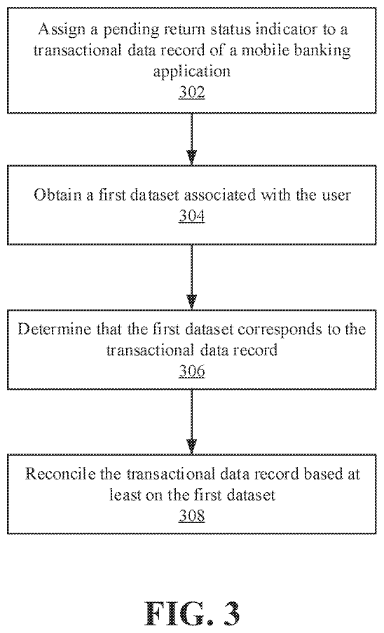

The DPRM system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-6. As illustrated in FIG. 2A, the apparatus 200 may include processor 202, memory 204, communications hardware 206, modeling engine 208, data modification engine 210, interface circuitry 212, content analysis engine 214, visualization engine 216, notification engine 218, and geofence circuitry 220, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

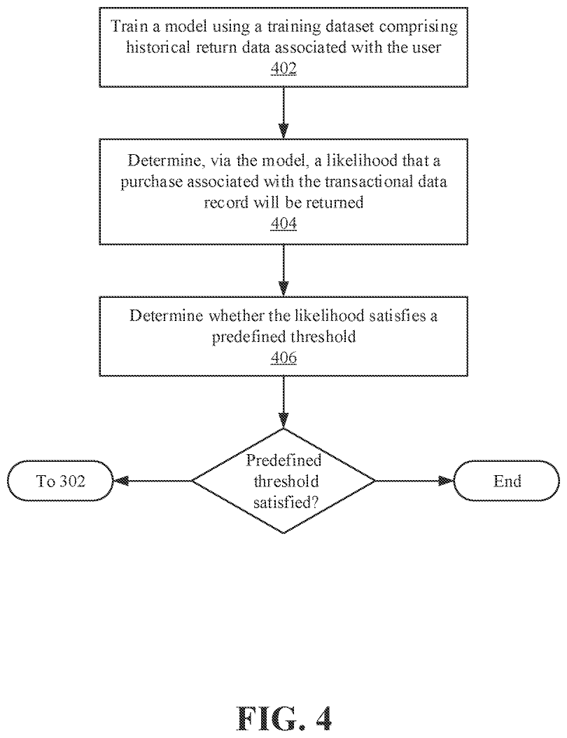

In addition, the apparatus 200 further comprises a modeling engine 208 that trains and leverages a model (e.g., a machine learning (ML) model) to predict a likelihood that a particular purchase will be returned by a user. The modeling engine 208 may utilize processor 202, memory 204, or any other hardware component included in the apparatus 200 to perform these and other operations, as described in connection with FIGS. 3 and 4 below. The modeling engine 208 may further utilize communications hardware 206 to gather data from a variety of sources (e.g., remote data sources 106A-106N, user devices 108A-108N, and/or storage device 110, as shown in FIG. 1), and/or exchange data with a user. In some embodiments, the modeling engine 208 may utilize one or more ML models and/or artificial intelligence techniques to determine a classification for an electronic file. For example, in some embodiments, the modeling engine 208 may process a transactional data record using a trained ML model (or multiple trained ML models) to determine a value representing a likelihood that that a purchase associated with the transactional data record will be returned. For example, a value satisfying (e.g., meeting or exceeding) a predefined threshold may indicate that the purchase will be returned, whereas a value failing to satisfy (e.g., falling below) the predefined threshold may indicate that the purchase will not be returned. In some embodiments, the model may be trained using labeled data in the form of historical return data for a user. In some embodiments, historical return data may include a plurality of historical transactional data records for which purchases were returned. In this regard, in some embodiments, the model may be trained in a supervised manner in order for the model to accurately predict whether a purchase will be returned.

In addition, the apparatus 200 further comprises a data modification engine 210 that assigns status indicators to transactional data records. In some embodiments, the data modification engine 210 may assign a pending return status indicator (further discussed herein) to a transactional data record of a mobile banking application. In some embodiments, the data modification engine 210 may assign a returned status indicator (further discussed herein) to a transactional data record of a mobile banking application. In some embodiments, the data modification engine 210 may assign one of a successful reconciliation status indicator or an unsuccessful reconciliation status indicator (further discussed herein) to a transactional data record of a mobile banking application. The data modification engine 210 may utilize processor 202, memory 204, or any other hardware component included in the apparatus 200 to perform these operations, as described in connection with FIGS. 3-6 below. The data modification engine 210 may further utilize communications hardware 206 to gather data from a variety of sources (e.g., remote data sources 106A-106N, user devices 108A-108N, and/or storage device 110, as shown in FIG. 1), and/or exchange data with a user.

In addition, the apparatus 200 further comprises interface circuitry 212 that obtains datasets (e.g., electronic files, such as digital receipts, email files (containing email messages), files containing return policy data, and/or the like) from third-party applications (e.g., from remote data sources 106A-106N). To obtain datasets, the interface circuitry 212 may communicate requests to third-party applications for the datasets and, in response, receive the datasets. In some embodiments, the DPRM system 102 (and/or an entity managing the DPRM system 102) may be involved in a preexisting partnership with one or more third parties (e.g., one or more merchants) through which datasets and other information regarding purchases, returns, shipping, and the like may be obtained. The interface circuitry 212 may utilize processor 202, memory 204, or any other hardware component included in the apparatus 200 to perform these operations, as described in connection with FIG. 3 below. The interface circuitry 212 may further utilize communications hardware 206 to gather data from a variety of sources (e.g., remote data sources 106A-106N, user devices 108A-108N, and/or storage device 110, as shown in FIG. 1), and/or exchange data with a user. In various embodiments, the interface circuitry 212 may comprise Application Programming Interface (API) functionality to facilitate seamless communication between distinct applications with the primary objective of retrieving datasets. In this regard, the interface circuitry 212 may employ standardized protocols and data structures to establish efficient and secure channels with third-party applications. For instance, the DPRM system 102 may generate API request (e.g., via interface circuitry 212) specifying desired actions and parameters (e.g., dataset retrieval). The interface circuitry 212 may then communicate with a target application (e.g., via a remote data source 106A-106N) and, in response, receive one or more datasets (e.g., in a standardized format). In various embodiments, the DPRM system 102, by way of a mobile banking application installed on a user device, may communicate with other applications installed on the user device (e.g., via servers (such as remote data sources) which manage or are otherwise associated with those applications) to obtain datasets from those applications. Example applications from which the DPRM system 102 may obtain electronic files may include (but are not limited to) other mobile banking applications or financial applications, email applications, messaging applications (e.g., Short Messaging Service (SMS) text applications), social media applications, merchant applications, cloud storage service applications, camera applications, photo storage applications, and similar applications. In general, the DPRM system 102 may connect to and obtain datasets from (e.g., via interface circuitry 112) any application configured to store datasets.

In addition, the apparatus 200 further comprises a content analysis engine 214 that determines whether a dataset corresponds to a transactional data record. To do so, in some embodiments, the content analysis engine 214 may extract a token set from a given dataset and determine whether a match between at least one token of the token set and at least one token associated with the transactional data record. In this regard, the content analysis engine 214 may utilize one or more natural language processing (NLP) techniques in order to extract information such as terms and/or values present within a dataset (e.g., an electronic file, such as in the context of a document file (e.g., an email message, or the like)). For example, the content analysis engine 214 may preprocess a dataset by removing punctuation and/or other elements. The content analysis engine 214 may then perform a tokenization operation on the preprocessed dataset to identify individual terms (e.g., tokens). The content analysis engine 214 may then process the identified terms in connection with a token set extracted from a transactional data record (e.g., data and metadata indicated by the transactional data record). In some embodiments, the content analysis engine 214 reconciles a transactional data record based at least on a dataset. In this regard, the content analysis engine 214 may determine a successful or unsuccessful reconciliation of a transactional data record based on whether a refund in the correct amount was issued and/or received for a purchase associated with the transactional data record. In some embodiments, the content analysis engine 214 also determines return policy data of a merchant associated with a transactional data record. To do so, the content analysis engine 214 may leverage communications hardware 206 and/or interface circuitry 212 to obtain a dataset that includes return policy data. The content analysis engine 214 may also parse the dataset to determine the return policy data. The content analysis engine 214 may utilize processor 202, memory 204, or any other hardware component included in the apparatus 200 to perform these operations, as described in connection with FIGS. 3-6 below. The content analysis engine 214 may further utilize communications hardware 206 to gather data from a variety of sources (e.g., remote data sources 106A-106N, user devices 108A-108N, and/or storage device 110, as shown in FIG. 1), and/or exchange data with a user.

In addition, the apparatus 200 further comprises visualization engine 216 that modifies visualizations of data presented within a mobile banking application. For example, in some embodiments, the visualization engine 216 may modify a visualization of a transactional data record (e.g., visualized as a line item transaction in a graphical listing of line item transactions) within the mobile banking application (e.g., in response to a successful or unsuccessful reconciliation of the transactional data record by the content analysis engine 214). For example, in some embodiments, the visualization engine 216 may modify a visualization of a transactional data record by altering a color of the visualization of a corresponding line item transaction and/or displaying a graphical icon representing a successful (or unsuccessful) reconciliation of the transactional data record in the visualization of the line item transaction (e.g., modifying a predefined area of the mobile banking application's user interface in which the line item transaction is displayed). To do so, the visualization engine 216 may generate the required visualization (e.g., a color change or graphical icon) in a standardized format (e.g., JSON, XML, an image, etc.) and cause transmission of visualization to the mobile application (e.g., at the user device), in order to modify a view of the mobile banking application's user interface to include the generated visualization. The visualization engine 216 may utilize processor 202, memory 204, communications hardware 206, content analysis engine 214, or any other hardware component included in the apparatus 200 to perform these operations, as described in connection with FIG. 3 below. The visualization engine 216 may further utilize communications hardware 206 to gather data from a variety of sources (e.g., remote data sources 106A-106N, user devices 108A-108N, and/or storage device 110, as shown in FIG. 1) and/or exchange data with a user.

In addition, the apparatus 200 further comprises a notification engine 218 that generates reminder data based on return policy data which may be included as part of a notification displayed or otherwise presented on a user device. The notification engine 218 may utilize processor 202, memory 204, communications hardware 206, content analysis engine 214, or any other hardware component included in the apparatus 200 to perform these operations, as described in connection with FIG. 3 below. The visualization engine 216 may further utilize communications hardware 206 to gather data from a variety of sources (e.g., remote data sources 106A-106N, user devices 108A-108N, and/or storage device 110, as shown in FIG. 1) and/or exchange data with a user.

In addition, the apparatus 200 further comprises geofence circuitry 220 that determines whether a device is within a predefined proximity of a physical location associated with a merchant by generating geofence boundaries based on the current location of a user device and/or location information of merchant. The geofence circuitry 220 may utilize processor 202, memory 204, or any other hardware component included in the apparatus 200 to perform these operations, as described in connection with FIGS. 3-6 below. The geofence circuitry 220 may further utilize communications hardware 206 to gather data from a variety of sources (e.g., remote data sources 106A-106N, user devices 108A-108N, and/or storage device 110, as shown in FIG. 1), and/or exchange data with a user, and in some embodiments may utilize processor 202 and/or memory 204 to generate geofence boundaries. The geofence circuitry 220 may utilize geolocation mapping services (e.g., Google Maps™, global position system (GPS), and/or the like) and/or location data received from one or more user devices 108A-108N to determine a current location of one or more users. In some embodiments, the geofence circuitry 220 may utilize the geolocation mapping services and the location data associated with a user to identify structural boundaries (e.g., building walls, fences, or the like) at the current location of the user. These structural boundaries may be used to identify instances in which a user device is within a predefined proximity of a merchant location.

Although components 202-220 are described in part using functional language, it will be understood that the particular implementations necessarily include the use of particular hardware. It should also be understood that certain of these components 202-220 may include similar or common hardware. For example, the modeling engine 208, data modification 210, interface circuitry 212, content analysis engine 214, visualization engine 216, notification engine 218, and geofence circuitry 220 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the modeling engine 208, data modification 210, interface circuitry 212, content analysis engine 214, visualization engine 216, notification engine 218, and geofence circuitry 220 may leverage processor 202, memory 204, or communications hardware 206 as described above, it will be understood that any of the modeling engine 208, data modification 210, interface circuitry 212, content analysis engine 214, visualization engine 216, notification engine 218, and geofence circuitry 220 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the modeling engine 208, data modification 210, interface circuitry 212, content analysis engine 214, visualization engine 216, notification engine 218, and geofence circuitry 220 comprise particular machinery designed for performing the functions described herein in connection with such elements of apparatus 200.

As illustrated in FIG. 2B, an apparatus 250 is shown that represents an example user device (e.g., any of user devices 108A-108N) or a device managed by or otherwise associated with a remote data source (e.g., any of remote data sources 106A-106N). The apparatus 250 includes processor 252, memory 254, and communications hardware 256, each of which is configured to be similar to the similarly named components described above in connection with FIG. 2A.

However, the apparatus 250 may also include geolocation circuitry 258, which includes hardware components designed for communicatively coupling with a satellite-based radio navigation system (e.g., global positioning system (GPS)) and/or a cellular network to determine the current location for the apparatus 250 (e.g., via GPS coordinates, radiolocation through triangulation between base station, or the like). The geolocation circuitry 258 may utilize processor 252, memory 254, or any other hardware component included in the apparatus 250 to perform these operations. The geolocation circuitry 258 may further utilize communications hardware 256 to communicate with navigation systems, cellular networks, and/or apparatus 200, or may otherwise utilize processor 252 and/or memory 254 to generate location data representative of the current location of the apparatus 250.

In addition, the apparatus 250 may also include user interface circuitry 260, which includes hardware components designed for receiving user inputs and rendering virtual graphics outputs. The user interface circuitry 250 may utilize processor 252, memory 254, or any other hardware component included in the apparatus 250 to perform these operations. The user interface circuitry 260 may further utilize communications hardware 256 to transmit data representative of a user input and/or receive data to render as a virtual graphics output, or may otherwise utilize processor 252 and/or memory 254 to generate data representative of a user input and/or generate virtual graphics output, e.g., from based on received data and via a mobile banking application. The user interface circuitry 260 may comprise one or more of a keyboard, pointing device, touchscreen, microphone with speech recognition interface, camera with gesture-based interface, or other input device capably of receiving various different user inputs. In addition, the user interface circuitry 260 may comprise a display device including one or more of a screen with graphical user interface (GUI), speaker, light emitting diode (LED), haptic technology device, or other output device capable of rendering information to a user.

In some embodiments, various components of the apparatuses 200 and 250 may be hosted remotely (e.g., by one or more cloud servers) and thus need not physically reside on the corresponding apparatus 200 or 250. For instance, some components of the apparatus 200 may not be physically proximate to the other components of apparatus 200. Similarly, some or all of the functionality described herein may be provided by third party circuitry. For example, a given apparatus 200 or 250 may access one or more third party circuitries in place of local circuitries for performing certain functions.

As will be appreciated based on this disclosure, example embodiments contemplated herein may be implemented by an apparatus 200 or 250. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDS, flash memory, optical storage devices, and magnetic storage devices. It should be appreciated, with respect to certain devices embodied by apparatus 200 as described in FIG. 2A or apparatus 250 as described in FIG. 2B, that loading the software instructions onto a computing device or apparatus produces a special-purpose machine comprising the means for implementing various functions described herein.

Having described specific components of example apparatuses 200 and 250, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by a system device of the DPRM system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, modeling engine 208, data modification 210, interface circuitry 212, content analysis engine 214, visualization engine 216, notification engine 218, geofence circuitry 220, and/or any combination thereof. It will be understood that user interaction with the DPRM system 102 may occur directly via communications hardware 206, or may instead be facilitated by a separate user device (e.g., any of user devices 108A-108N), as shown in FIG. 1, and which may have similar or equivalent physical componentry facilitating such user interaction.

Turning first to FIG. 3, example operations are shown for digital product reimbursement management.

As shown by operation 302, the apparatus 200 includes means, such as processor 202, memory 204, data modification engine 210, and/or the like, for assigning a pending return status indicator to a transactional data record of a mobile banking application. In some embodiments, a transactional data record may be generated and stored automatically (e.g., by a financial institution or other entity associated with DPRM system 102) in response to a transaction occurring and comprise a data structure that includes data and/or metadata representing various attributes of a transaction. A transactional data record may be associated with a particular user (e.g., a user who conducted the transaction). For example, a transactional data record may include a transaction identifier (e.g., a unique identifier for the transaction (generated sequentially or using an algorithm) which may be used for tracking and/or referencing the transaction), a date on which the transaction occurred, a time at which the transaction occurred, a transaction type (e.g., an identifier that indicates whether the transaction is a purchase, return, transfer, or the like), a transaction amount (e.g., a monetary value associated with the transaction, which may include a total amount, taxes, discounts, additional charges, etc.), a payment method (e.g., a method used to perform the transaction, such as credit card, debit card, check, electronic funds transfer, etc.), customer information (e.g., data about the customer who performed the transaction, such as name, contact information, account number, customer identifier, etc.), product or service information (e.g., details about the products or services involved in the transaction, such as product or service names, descriptions, Stock Keeping Units (SKUs), quantities, prices, etc.), location data (e.g., indicator(s) of a physical (or digital) location where the transaction took place (e.g., a particular store branch, online platform, etc.)), a merchant name, a transaction status (an indicator as to whether the transaction was completed, voided, canceled, pending, etc.), authorization codes (e.g., a unique authorization number assigned to the transaction), shipping information (e.g., shipping details such as shipping address, shipping method, tracking number(s), etc.), transaction source (e.g., data indicating how the transaction was conducted, such as in-store, online, through a mobile application, over the phone, or the like), a transaction category or classification (e.g., categorized as a sale, expense, investment, etc.), and/or the like.

In some embodiments, at least some portion of information included in a transactional data record may be visually presented within the mobile banking application as a line item transaction. A line item transaction may visually present, for example, the date of the transaction, a merchant name, and a transaction amount. In some embodiments, the user may view a listing of line item transactions (e.g., recent transactions the user conducted, organized by date and/or time) within the mobile banking application installed on a user device. For instance, apparatus 250 (e.g., any of user devices 108A-108N) includes means, such as processor 252, memory 254, user interface circuitry 260, and/or the like, for causing display of a line item transaction listing via a mobile banking application installed on the user device.

In some embodiments, a pending return status indicator may comprise a data structure including data that indicates that a purchase associated with the transactional data record is to be returned but has not yet been returned. In some embodiments, the data modification engine 210 may assign a pending return status indicator to a transactional data record in response to a user input via the mobile banking application. For instance, in some embodiments, the user, via their user device, may select (e.g., tap, double-tap, swipe, and/or the like) a line item transaction in the listing of line item transactions presented via the mobile banking application installed on their user device, and, by doing so, the data modification engine 210 may assign a pending return status indicator to a transactional data record associated with the selected line item transaction. In this manner, a user is enabled to efficiently select and monitor line item transactions associated with product(s) which they plan to return.

Additionally, the DPRM system 102 enables the user to effectively track pending returns (as well as returned purchases and reconciled purchases, as discussed further below) by modifying visualizations of line item transactions that are associated with a transactional data record assigned a pending return status indicator. In this regard, the apparatus 200 includes means, such as processor 202, memory 204, visualization engine 216, and/or the like, for modifying a visualization of a transactional data record within the mobile banking application. By modifying a visualization of a transactional data record within the mobile banking application, certain line item transactions, e.g., those which are associated with a transactional data record having a pending return status indicator assigned, are caused to appear differently than other line item transactions which do not have a pending return status indicator assigned. For instance, in some embodiments, the visualization engine 216 may modify the visualization of a transactional data record by altering a color of the visualization of the transactional data record. In this regard, for example, in response to a user selecting a line item transaction, the visualization engine 216 may alter the color of the line item transaction, causing, for example, a yellow color to be applied to the line item transaction (whereas other line item transactions have a white or neutral color applied). Additionally or alternatively, in some embodiments, the visualization engine 216 may modify the visualization of a transactional data record by causing display of a graphical icon representing a pending return status of the transactional data record in the visualization of the transactional data record. For example, a graphical icon, such as an image of a check mark or arrow (or any symbol which may convey a pending return), may be displayed adjacent to or within the visualization of the line item transaction (e.g., next to the purchase amount) having been assigned a pending return status indicator.

As discussed above, the user, via their user device, may select a line item transaction in the listing of line item transactions presented via the mobile banking application installed on their user device, and, in response, the data modification engine 210 may assign a pending return status indicator to a transactional data record associated with the selected line item transaction. In some embodiments, the manner in which line item transactions are selected may be distinct from manners in which other user interface (UI) elements of the mobile banking application are selected. For instance, a user may navigate through various UIs of the mobile banking application by tapping once on certain UI elements such as buttons, links, and the like. In some examples, a user may tap once on a line item transaction in order to view additional details about the line item transaction. To distinguish a user input specifically for assigning a pending return status indicator to a transactional data record, the DPRM system 102 may require a more gestured user input than a simple one-tap selection. For example, a gestured input may comprise a swiping of the line item transaction. For example, the user may use their finger to swipe (left, right, up, down, or in another certain direction) a display screen of their user device over the line item transaction, and, in response, the DPRM system 102 may receive and process the gestured input and assign a pending return status indicator to the line item transaction. By doing so, the DPRM system 102 may avoid situations in which a line item transaction was mistakenly selected (e.g., via a one-tap selection) as a pending return (which may lead to user confusion at a later time). Further, by enabling a gestured input, such as a swipe, both UI and display screen space is conserved in that a separate button for assigning a pending return status indicator to a transactional data record is not required to be displayed. In some embodiments, to remove a pending return status indicator from a transactional data record, a user may perform the same gesture (e.g., a swipe) a second time on the line item transaction. For example, if a user changes their mind and wants to keep the purchased item, the user may swipe the line item transaction a second time to remove its pending return status.

In some embodiments, as discussed above, a pending return status indicator may be assigned to a transactional data record in response to a user input via the mobile banking application. Additionally or alternatively, however, in some embodiments, a pending return status indicator may be assigned to a transactional data record automatically by the DPRM system 102. For example, in some embodiments, the DPRM system 102 may leverage a trained ML model to predict whether a certain purchase will be returned by a particular user, and automatically assign a pending return status indicator to a transactional data record for that purchase. Thus, line item transactions may be visually modified (e.g., by the visualization engine 216 as discussed above) without any input from the user. Turning briefly to FIG. 4, example operations are shown for using a model to determine whether to assign a pending return status indicator to a transactional data record.

As shown by operation 402, the apparatus 200 includes means, such as processor 202, memory 204, modeling engine 208, and/or the like, for training a model using a training dataset comprising historical return data associated with the user. For example, over time, the DPRM system 102 may collect data (e.g., with user permissions in some embodiments) from both passive and active user activity within the mobile banking application. The data may be continuously collected, e.g., at predefined intervals (such as, for example, once an hour, once a day, every 2 seconds, etc.). The collected data may comprise return data, which may include specific transactional data records that include purchases that have been returned, selected for a pending return status to be assigned, have had refunds issued for, and the like. The collected data may also include transactional data records which have not been returned. More generally, the collected data may comprise data regarding any financial activity associated with the user, whether performed actively by the user or passively through other systems. Through this collected data, the modeling engine 208 may generate a training dataset (e.g., of labeled data) comprise all or at least some portion of the collected data (e.g., return data). The modeling engine 208 may then train the model (e.g., in a supervised manner) such that the model can output a value representing a likelihood that a given purchase will be returned. Through training, the model may learn to identify patterns and relationships in the training data that can be used to predict a likelihood of return.

Once the model trained, the modeling engine 208 may provide a transactional data record (e.g., that includes all data known about a particular transaction) to the trained model. By processing the transactional data record, the model may then output a value representing a likelihood that a purchase associated with the transactional data record will be returned. In this regard, as shown by operation 404, the apparatus 200 includes means, such as processor 202, memory 204, modeling engine 208, and/or the like, for determining, via the model, a likelihood that a purchase associated with the transactional data record will be returned. In some embodiments, the likelihood may comprise a value between 0 and 1, with a value closer to 1 indicating a greater likelihood that the purchase will be returned, and a value closer to 0 indicating a greater likelihood that the purchase will not be returned.

As shown by operation 406, the apparatus 200 includes means, such as processor 202, memory 204, modeling engine 208, and/or the like, for determining whether the likelihood satisfies a predefined threshold. For instance, the modeling engine 208 may compare the likelihood value with a predefined threshold value to determine whether the likelihood value meets or exceeds the predefined threshold value. The DPRM system 102 may then use this determination as a basis for automatically assigning a pending return status indicator to the transactional data record. As one example, a likelihood value meeting or exceeding a predefined threshold value of 0.75 may result in automatically assigning a pending return status indicator to the transactional data record. As shown in FIG. 4, if the likelihood satisfies the predefined threshold, the method may continue to operation 302 (as described above), wherein the data modification engine 210 assigns a pending return status indicator to the transactional data record of the mobile banking application. Alternatively, if the likelihood does not satisfy the predefined threshold, the method may end, and the transactional data record will not be assigned a pending return status indicator. In various embodiments, the DPRM system 102 may leverage the modeling engine 208 to analyze each transactional data record (as they are received by the DPRM system 102) for a given user using the trained model to determine whether a pending return status indicator should be assigned.

Additionally, in various embodiments, the DPRM system 102 may enable the user to customize settings for assigning pending return status indicators to transactional data records. For instance, through the mobile banking application installed on a user device, the user may configure the DPRM system 102 to automatically assign a pending return status indicator to transactional data records that meet certain criteria. As one example, a user may configure the DPRM system 102 such that that all transactional data records that specify a particular merchant name (i.e., transactions conducted with a particular merchant) are to be automatically assigned a pending return status indicator by the DPRM system 102. As another example, a user may configure the DPRM system 102 such that all transactional data records that indicate a time within a certain range are to be automatically assigned a pending return status indicator by the DPRM system 102. For example, a user may have a bad habit of making late night online purchases, and wish to have these purchases automatically flagged as potential returns (e.g., as a reminder to the user at a later time when viewing their line item transactions in their mobile banking application). Similarly, a user may configure the DPRM system 102 to automatically assign a pending return status indicator to transactions based on other criteria, such as other data indicated in the transactional data record. For example, a pending return status indicator may be automatically assigned to a transactional data record based on a location of the purchase, a date of the purchase, and/or any other attributes of the purchase indicated by the transactional data record.

Once a transaction is assigned a pending return status indicator, the DPRM system 102 may take various actions to monitor a status of the return of the purchase (such as if, when, and how the purchase was returned) with or without direct user input. To do so, the DPRM system 102 may obtain one or more datasets from various sources. A dataset may comprise an electronic file, message, or the like that may pertain to a purchase associated with the transactional data record. For example, a dataset may comprise an email message the user has received in their personal email. As another example, a dataset may comprise a digital receipt or invoice associated with the purchase. As yet another example, a dataset may comprise an electronic file containing information related to the purchase or merchant associated with the purchase.

As shown by operation 304, the apparatus 200 includes means, such as processor 202, memory 204, communications hardware 206, interface circuitry 212, and/or the like, for obtaining a first dataset associated with the user. In some embodiments, the dataset may comprise an electronic file and may be associated with a third-party application in that the electronic file is obtained from the third-party application. For instance, a third-party application may store the electronic file, at least temporarily, such that interface circuitry 212 may connect with the third-party application (e.g., via an API as discussed above) and retrieve the electronic file. For example, the third-party application may be an email application wherein the electronic file is stored as an email message (e.g., an email message from a merchant informing the user of an initiated return). For example, the DPRM system 102 may obtain a user's emails in order to scrape the emails to determine whether a return for a particular purchase has been made. In this regard, for example, a user may receive an email from a merchant indicating that the merchant has received the user's return request, along with additional data such as product information and the like. From this, the DPRM system 102 may infer that a return is actually in progress. As another example, the third-party application may be a camera application on a user device with which a user has taken a photograph of physical financial document, such as a receipt, invoice, or the like. In this example, the dataset may comprise an image file of the physical document.

In some embodiments, the interface circuitry 212 may automatically obtain the dataset (and one or more other datasets), e.g., through automatic API calls to one or more third-party applications installed on a user device. For example, the interface circuitry 212 may regularly (e.g., at predefined time intervals) communicate (e.g., via API calls) to one or more third-party applications in order to retrieve datasets not yet processed by the DPRM system 102. For instance, the DPRM system 102 may (with user permissions) regularly pull email messages from a user's email inbox in order to determine relevancy of the email messages to pending returns flagged in the DPRM system 102 as discussed above. In this regard, the apparatus 200 includes means, such as processor 202, memory 204, interface circuitry 212, and/or the like, for communicating a request to at least one third-party application. The apparatus 200 also includes means, such as processor 202, memory 204, interface circuitry 212, and/or the like, for receiving the first dataset in response to the request.

In some embodiments, the interface circuitry 212 may obtain the dataset(s) in response to user interaction, such as a request made by the user via the mobile banking application to retrieve one or more datasets from one or more third-party applications. In some embodiments, a user may upload an electronic file stored on their user device (e.g., in a photos application) directly to the mobile banking application such that the interface circuitry 212 may obtain the electronic file through the upload.

In some embodiments, the DPRM system 102 may receive the first dataset directly from a merchant system (e.g., a remote data source 106A-106N). For example, as discussed above, in some embodiments, the DPRM system 102 (and/or an entity managing the DPRM system 102) may be involved in a preexisting partnership with one or more third parties (e.g., one or more merchants) through which datasets and other information regarding purchases, returns, shipping, and the like may be obtained. That is, when a user initiates a return, the merchant may automatically provide return information to a bank or other managing entity of the DPRM system 102.

As shown by operation 306, the apparatus 200 includes means, such as processor 202, memory 204, content analysis engine 214, and/or the like, for determining whether the first dataset corresponds to the transactional data record. In this regard, the content analysis engine 214 may process the first dataset to determine whether the dataset contains relevant information to the transactional data record or otherwise is directed to a purchase associated with the transactional data record. To do so, the DPRM system 102 may compare tokens of the first dataset to tokens of the transactional data record to determine whether a similarity threshold is satisfied. A token may comprise an individual unit or component into which the dataset is divided for analysis. For example, a token may comprise a word, sentence, value, character, or the like. In this regard, the apparatus 200 includes means, such as processor 202, memory 204, content analysis engine 214, and/or the like, for extracting a token set from the first dataset. In some embodiments, the content analysis engine 214 may perform tokenization operations on both the first dataset and the transactional data record. In this regard, the apparatus 200 includes means, such as processor 202, memory 204, content analysis engine 214, and/or the like, for extracting a token set from the transactional data record. The apparatus 200 also includes means, such as processor 202, memory 204, content analysis engine 214, and/or the like, for and determining a match between at least one token of the token set and at least one token associated with the transactional data record.

In some embodiments, the content analysis engine 214 may determine whether one or more tokens of a token set for the first dataset are present within the token set for the transactional data record by utilizing a machine learning (ML) model or the like perform a comparison of the token sets. For example, the content analysis engine 208 may utilize a model which has been trained to output a confidence score representing a likelihood that the first dataset corresponds to the transactional data record. In some embodiments, for example, the confidence score may correspond to a number of token matches between the token sets. In this regard, a higher number of matching tokens identified may correspond to a higher confidence score. In this regard, the apparatus 200 includes means, such as processor 202, memory 204, content analysis engine 214, and/or the like, for determining a confidence score for the first dataset based on the identified one or more token matches. For example, the confidence score may comprise a value between 0 and 1, which a value closer to 1 indicating a higher likelihood that the first dataset corresponds to the transactional data record. In some embodiments, the content analysis engine 214 may compare the confidence score to a predefined threshold to determine whether the confidence score satisfies the predefined threshold. For example, if a confidence score meets or exceeds 0.6, the content analysis engine 214 may determine that the first dataset corresponds to the transactional data record. Similarly, if the confidence score falls below 0.6, the content analysis engine 214 may determine that the first dataset does not correspond to the transactional data record (in which case the DPRM system 102 may ignore the first dataset and continue to process other datasets).

In some embodiments, in response to determining that the first dataset corresponds to the transactional data record, the data modification engine 210 may automatically assign a returned status indicator to the transactional data record. For example, if the dataset corresponds to the transactional data record and includes data (e.g., tokens) indicating a return of the purchase, the data modification engine 210 may update (e.g., without user input) the transactional data record to include a returned status indicator. A returned status indicator may comprise a data structure including data that indicates that a purchase associated with the transactional data record has been returned to a merchant. In this regard, the apparatus 200 includes means, such as processor 202, memory 204, data modification engine 210, and/or the like, for assigning a returned status indicator to the transactional data record of the mobile banking application. In some embodiments, by assigning a returned status indicator to the transactional data record, the data modification engine 210 may also remove the pending return status indicator from the transactional data record.

In some embodiments, the DPRM system 102 may modify visualizations of line item transactions that are associated with a transactional data record assigned a returned status indicator, similar to how the DPRM system 102 may modify visualizations of line item transactions that are associated with a transactional data record assigned a pending return status indicator. By doing so, a user may more easily distinguish transactions that are pending return, have been returned, and are not to be returned. For instance, in some embodiments, the visualization engine 216 may modify the visualization of a transactional data record having been assigned a returned status indicator by altering a color of the visualization of the transactional data record. For example, the visualization engine 216 may alter the color of the line item transaction associated with a transactional data record assigned a returned status, causing, for example, a blue color to be applied to the line item transaction, whereas line item transactions that are not to be returned (e.g., not assigned any indicator) have a white or neutral color applied and line item transactions associated with transactional data records assigned a pending return status have a yellow color. Additionally or alternatively, in some embodiments, the visualization engine 216 may modify the visualization of a transactional data record assigned a returned status by causing display of a graphical icon representing a returned status of the transactional data record in the visualization of the line item transaction associated with the transactional data record. For example, a graphical icon, such as any symbol which may convey a pending return, may be displayed adjacent to or within the visualization of the line item transaction (e.g., next to the purchase amount) having been assigned a returned status indicator.

Additionally or alternatively, in some embodiments, the data modification engine 210 may assign a returned status indicator to a transactional data record in response to a user input via the mobile banking application. For instance, in some embodiments, the user, via their user device, may select (e.g., tap, double-tap, swipe, and/or the like) a line item transaction in the listing of line item transactions presented via the mobile banking application installed on their user device, and, by doing so, the data modification engine 210 may assign a returned status indicator to a transactional data record associated with the selected line item transaction. In this manner, a user is enabled to efficiently select and monitor line item transactions associated with product(s) which they have returned. In some embodiments (similar to assigning a pending return status as discussed above), to distinguish a user input specifically for assigning a returned status indicator to a transactional data record, the DPRM system 102 may require a more gestured user input than a simple one-tap selection. For example, a gestured input may comprise a swiping of the line item transaction. For example, the user may use their finger to swipe (left, right, up, down, or in another certain direction, e.g., a direction different than a swiping direction for assigning a pending return status) a display screen of their user device over the line item transaction, and, in response, the DPRM system 102 may receive and process the gestured input and assign (e.g., via data modification engine 210) a returned status indicator to the line item transaction.

As shown by operation 308, the apparatus 200 includes means, such as processor 202, memory 204, content analysis engine 214, and/or the like, for reconciling, by the content analysis engine, the transactional data record based at least on the first dataset. For example, a transactional data record may be successfully reconciled when a credit for a return is issued to the user in the correct amount. In some embodiments, for example, the first dataset may indicate that a credit has been issued. In response, the DPRM system 102 may assign a reconciliation status to the transactional data record. In this regard, the apparatus 200 includes means, such as processor 202, memory 204, data modification engine 210, and/or the like, for assigning one of a successful reconciliation status indicator or an unsuccessful reconciliation status indicator to the transactional data record of the mobile banking application. For example, if the first dataset indicates a credit has been issued in an amount that matches a purchase amount of the transactional data record, the data modification engine 210 may assign a successful reconciliation status indicator to the transactional data record. However, if the first dataset indicates a credit has been issued in an incorrect amount (e.g., an amount that matches a purchase amount of the transactional data record) or contains another discrepancy, the data modification engine 210 may assign an unsuccessful reconciliation status indicator to the transactional data record, which may prompt the user to look into the transactions and resolve the issue.

In some embodiments, reconciling the transactional data record may be further based on a second transactional data record indicating a credit of a purchase amount indicated by the transactional data record. In this regard, the DPRM system 102 may receive a second transactional data record that includes an amount credited in the same amount of a purchase of an earlier received transactional data record. In response, the DPRM system 102 may assign a reconciliation status to the transactional data record. For example, if the second transactional data record indicates a credit has been issued in an amount that matches a purchase amount of the transactional data record, the data modification engine 210 may assign a successful reconciliation status indicator to the transactional data record. However, if the second transactional data record indicates a credit has been issued in an incorrect amount (e.g., an amount that matches a purchase amount of the transactional data record) or contains another discrepancy, the data modification engine 210 may assign an unsuccessful reconciliation status indicator to the transactional data record.

In some embodiments, the DPRM system 102 may modify visualizations of line item transactions that are associated with a transactional data record assigned a reconciliation indicator (e.g., a successful reconciliation indicator or an unsuccessful reconciliation indicator), similar to how the DPRM system 102 may modify visualizations of line item transactions that are associated with a transactional data record assigned a pending return status indicator or returned status indicator. By doing so, a user may more easily distinguish transactions that are pending return, have been returned, have been successfully or unsuccessfully reconciled, and are not to be returned. For instance, in some embodiments, the visualization engine 216 may modify the visualization of a transactional data record having been assigned a reconciliation status indicator by altering a color of the visualization of the transactional data record. For example, the visualization engine 216 may alter the color of the line item transaction associated with a transactional data record assigned a successful reconciliation status, causing, for example, a green color to be applied to the line item transaction, whereas line item transactions that are not to be returned (e.g., not assigned any indicator) have a white or neutral color applied, line item transactions associated with transactional data records assigned a returned status have a blue color, and line item transactions associated with transactional data records assigned a pending return status have a yellow color. Likewise, for example, the visualization engine 216 may alter the color of the line item transaction associated with a transactional data record assigned an unsuccessful reconciliation status, causing, for example, a red color to be applied to the line item transaction. Additionally or alternatively, in some embodiments, the visualization engine 216 may modify the visualization of a transactional data record assigned a returned status by causing display of a graphical icon representing a returned status of the transactional data record in the visualization of the line item transaction associated with the transactional data record. For example, a graphical icon, such as any symbol which may convey a successful or unsuccessful reconciliation, may be displayed adjacent to or within the visualization of the line item transaction (e.g., next to the purchase amount) having been assigned a successful or unsuccessful reconciliation indicator.

In some embodiments, for example, a user may receive a refund in the form of store credit as opposed to direct funds. In some embodiments, the DPRM system 102 may track received store credit for a user. For example, the DPRM system 102, through a preexisting partnership with a merchant, may receive a dataset indicating an amount of store credit the user possesses. The DPRM system 102 may store (e.g., in storage device 110) a log of accumulated store credit from multiple returns and cause transmission of notifications (as further discussed below) that include reminders when store credit is nearing expiration (e.g., store credit may only be redeemable up to 12 months after a return).

In some embodiments, the DPRM system 102 may assist a user with a pending return by determining return policy data and presenting the return policy data, e.g., visually via the mobile banking application, to the user such that the user is informed of certain requirements for returning the purchase. In some embodiments, the DPRM system 102 may determine return policy data in response to a transactional data record being assigned a pending return status indicator.

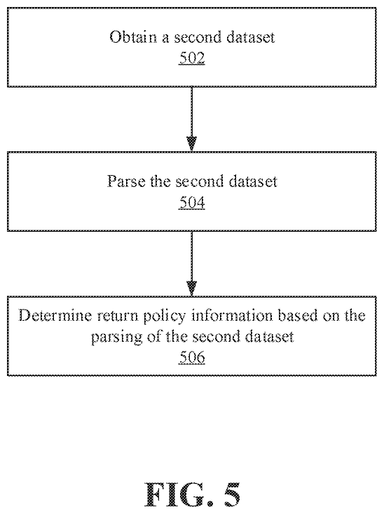

Turning briefly to FIG. 5, example operations are shown for determining return policy information. In some embodiments, the DPRM system 102 may obtain a dataset that includes return policy information for a given merchant. As shown by operation 502, the apparatus 200 includes means, such as processor 202, memory 204, communications hardware 206, interface circuitry 212, and/or the like, for obtaining a second dataset (e.g., a dataset that includes return policy data). Return policy data may comprise a structured collection of information provided by a merchant that outlines terms and conditions under which customers can return purchased products or seek refunds. Return policy data may include details about the timeframe within which returns are accepted (i.e., a return window), eligibility criteria for returns, processes for initiating a return, accepted reasons for returns, associated costs or restocking fees for returns, and/or the like.

Return policy data may be obtained by the DPRM system 102 in various ways. In some embodiments, a dataset that includes return policy data may be automatically received from a merchant. For example, a bank or other entity that manages the DPRM system 102 may enter into partnerships with one or more merchants in order to facilitate the process of customer returns more effectively. In this regard, the DPRM system 102 may receive a plurality of datasets containing return policy information from a plurality of partnered merchants. The DPRM system 102 may store these datasets and reference them to obtain return policy data once a transactional data record is assigned a pending return status.

In some embodiments, the DPRM system 102 may obtain a dataset that includes return policy data by requesting the dataset from a server or device associated with a merchant (e.g., a remote data source 106A-106N). For instance, the DPRM system 102 may utilize one or more API calls to communicate with a remote server of a merchant in order to request and receive a dataset that includes return policy data for the merchant. In this regard, the apparatus 200 includes means, such as processor 202, memory 204, interface circuitry 212, and/or the like, for communicating a request to a merchant device associated with the merchant. For example, the request may comprise an API request that specifies return policy data to be returned. The apparatus 200 also includes means, such as processor 202, memory 204, interface circuitry 212, and/or the like, for receiving the return policy data in response to the request.

In some embodiments, the DPRM system 102 may obtain a dataset that includes return policy data by receiving the dataset as an upload via the mobile banking application. For example, in some embodiments, a user may utilize the mobile banking application to upload an image of a physical receipt for the purchase. In some examples, the physical receipt may include text that dictates a return policy of the merchant.

Once the dataset containing return policy data is obtained, the DPRM system 102 may parse the dataset and extract return policy data from the dataset. In this regard, as shown by operation 504, the apparatus 200 includes means, such as processor 202, memory 204, content analysis engine 214, and/or the like, for parsing the second dataset to determine return policy data. In some embodiments, this may include using natural language processing (NLP) techniques to parse text and identify relevant sections of the dataset likely to contain return policy information. For example, the content analysis engine 214 may perform sentence or paragraph tokenization to convert text into smaller units. The content analysis engine 214 may also perform name entity recognition and/or keyword matching to identify phrases or terms common to return policies. Once identified, the content analysis engine 214 may extract specific details from the identified return policy data such as, for example, return window, accepted reasons for returns, refund methods, return shipping instructions and/or costs, restocking fees, and the like. In this regard, as shown by operation 506, the apparatus 200 includes means, such as processor 202, memory 204, content analysis engine 214, and/or the like, for determining return policy information based on the parsing of the second dataset. The content analysis engine 214 may then store (e.g., in storage device 110, memory 204, and/or the like) extracted return policy data in a structured format for future use.

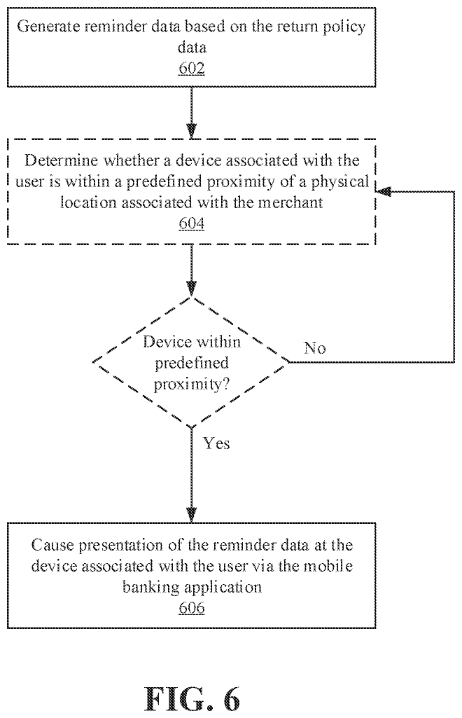

In some embodiments, the DPRM system 102 may leverage return policy data to generate and transmit reminders to a user regarding a purchase intended to be returned (e.g., a transactional data record having been assigned a pending return status indicator). Turning to FIG. 6, example operations are shown for generating and causing presentation of reminder data.

As shown by operation 602, the apparatus 200 includes means, such as processor 202, memory 204, notification engine 214, and/or the like, for generating reminder data based on return policy data. In some embodiments, reminders may be presented to a user via the mobile banking application installed on a user device. In this manner, the DPRM system 102 may utilize a combination of server-side processing and client-side integration to present reminders to a user at relevant locations and/or times. The notification engine 218 may leverage both a transactional data record and return policy data (associated with a merchant indicated by the transactional data record) to generate reminder data. Reminder data may include information (e.g., in text format) that may be presented at a user device via a notification (e.g., a push notification) by a mobile banking application. As one example, reminder data may include a message to the user instructing the user that they have 3 days remaining in the return window for the purchase.

In some embodiments, reminder data may be in a plain language format (e.g., in one or more sentences which may be easily read and understood by a human). In this regard, in some embodiments, the notification engine 218 may employ a natural language generation (NLG) or data rendering technique which uses structured data (e.g., fields and/or variables indicated by the return policy data and/or transactional data record) to generate a coherent, human-readable sentence(s). To do so, the notification engine 218 may use predefined templates which outline formats for plain language sentences and defines sentence structure and placeholders for data.

In some embodiments, the notification engine 218 may also define various rules and logic for when notifications should be presented. As shown in FIG. 6, in some embodiments, reminder data may be presented (e.g., in a notification) based on a current location of a user device. For instance, in some embodiments, a user device (e.g., via a mobile banking application) may provide current location information continuously to the DPRM system 102. In this regard, the apparatus 200 includes means, such as processor 202, memory 204, communications hardware 206, and/or the like, for receiving, from a user device, location data indicating a current location of the user device. For example, through a mobile banking application installed on a user device, location data of the user device may be shared with the DPRM system 102 (e.g., according to user permissions). In this regard, in some embodiments, the DPRM system 102 may continuously (e.g., at predefined time intervals) collect location data from a user device. Location data may be obtained via geolocation circuitry 258 of the user device, which may leverage GPS, Wi-Fi, cellular network triangulation, and/or other location sensing technologies of the user device. In some embodiments, location data may include latitude and longitude coordinates as well as contextual information such as timestamps, altitude, and the like.

As shown by operation 604, the apparatus 200 includes means, such as processor 202, memory 204, geofence circuitry 220, and/or the like, for determining whether a device associated with the user is within a predefined proximity of a physical location associated with the merchant. To do so, the geofence circuitry 220 may leverage a set of predefined geofence information (e.g., stored by the DPRM system 102 in storage device 110 and/or memory 204). The predefined geofence information may define geofences using GPS coordinates that correspond to boundaries of merchant locations (e.g., retail shops, etc.). The geofence circuitry 220 may compare received location data indicating a current location of the user device with predefined geofence information (e.g., using a geometric calculation to determine if the received coordinates fall within defined boundaries of a geofence).

As shown in FIG. 6, if the geofence circuitry 220 determines that the device is not within a predefined proximity of a physical location associated with a merchant, the method may return to operation 604 wherein the DPRM system 102 may continue to periodically determine whether the user device is within a predefined proximity of a physical location associated with a merchant.

In some embodiments, if the geofence circuitry 220 determines that the device is within a predefined proximity of a physical location associated with a merchant, the method may return to operation 606 wherein the apparatus 200 includes means, such as processor 202, memory 204, communications hardware 206, and/or the like, for causing presentation of the reminder data at the device associated with the user via the mobile banking application. In this regard, the DPRM system 102 may cause transmission of reminder data using communications hardware 206 to a user device using a communication protocol (e.g., a push notification service the mobile banking application is registered with). In response to receiving the reminder data, the mobile banking application processes the reminder data and displays the notification (e.g., in the form of a banner or alert). For example, when a user enters a merchant location, they may receive a notification on the user device reminding them that they have a purchase that is flagged as a pending return.

Additionally or alternatively, in some embodiments, reminder data may be presented (e.g., in a notification) based on a time threshold. In this regard, the apparatus 200 includes means, such as processor 202, memory 204, communications hardware 206, notification engine 218, and/or the like, for causing presentation of reminder data at a device associated with the user via the mobile banking application in response to determining a time threshold associated with the return policy data has been satisfied. For instance, the notification engine 218 may determine one or more time thresholds based on the return policy data and/or transactional data record. For example, if return policy data specifies a 30-day return window, and the transactional data record indicates a purchase date of September 1, the notification engine 218 may determine a time threshold of 25 days, after which a notification may be presented to the user (e.g., on September 25) indicating that the return window is expiring soon.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved digital product reimbursement management. Example embodiments thus provide tools that overcome the problems faced by traditional manual processes for tracking refunds and returns. For instance, embodiments herein enable returns and refunds to be tracked more efficiently through a centralized location (e.g., a mobile banking application), reducing the administrative burden that would otherwise be placed on an individual when attempting to track returns and refunds originating from a plurality of different merchants. In addition, embodiments minimize the risk of human error in recording return and refund data, leading to more accurate and reliable records. Additionally, users can check the status of their returns and refunds in real-time, reducing the need for customer support inquiries and enhancing transparency. Further, embodiments described herein integrate refund and return tracking into a mobile banking application itself, expanding the potential user base significantly, and allowing use of refund tracking processes even for those without pre-existing detailed awareness of their financial transactions, and without the possibility for third-party data breaches related to transaction data. As these examples all illustrate, example embodiments contemplated herein provide technical solutions that solve real-world problems faced during traditional manual processes for tracking refunds and returns.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
assigning, by a data modification engine, a pending return status indicator to a transactional data record of a mobile banking application, wherein the transactional data record is associated with a user;
obtaining, by interface circuitry, a first dataset associated with the user;
determining, by a transaction analysis engine, that the first dataset corresponds to the transactional data record; and
reconciling, by the transaction analysis engine, the transactional data record based at least on the first dataset.

2. The method of claim 1, further comprising:
training, by a modeling engine, a model using a training dataset comprising historical return data associated with the user;
determining, by the modeling engine and via the model, a likelihood that a purchase associated with the transactional data record will be returned; and
determining, by the modeling engine, that the likelihood satisfies a predefined threshold,
wherein the pending return status indicator is assigned to the transactional data record in response to determining that the likelihood satisfies the predefined threshold.

3. The method of claim 1, wherein the pending return status indicator is assigned to the transactional data record in response to a user input via the mobile banking application.

4. The method of claim 1, wherein assigning the pending return status indicator to a transactional data record of a mobile banking application comprises:
modifying, by a visualization engine, a visualization of the transactional data record within the mobile banking application.

5. The method of claim 4, wherein modifying the visualization of the transactional data record comprises at least one of:
altering a color of the visualization of the transactional data record, and
causing display of a graphical icon representing a pending return status of the transactional data record in the visualization of the transactional data record.

6. The method of claim 1, wherein obtaining the first dataset comprises:
communicating, by the interface circuitry, a request to at least one third-party application; and
receiving, by the interface circuitry, the first dataset in response to the request.

7. The method of claim 1, wherein the first dataset is obtained in response to an upload of the first dataset via the mobile banking application.

8. The method of claim 1, wherein the first dataset comprises one or more of an email file or a digital receipt.

9. The method of claim 1, wherein determining that the first dataset corresponds to the transactional data record comprises:
extracting, by a content analysis engine, a token set from the first dataset;
determining, by the content analysis engine, a match between at least one token of the token set and at least one token associated with the transactional data record.

10. The method of claim 1, further comprising, in response to determining that the first dataset corresponds to the transactional data record:
assigning, by the data modification engine, a returned status indicator to the transactional data record of the mobile banking application.

11. The method of claim 1, further comprising, in response to reconciling the transactional data record based on the first dataset:
assigning, by the data modification engine, one of a successful reconciliation status indicator or an unsuccessful reconciliation status indicator to the transactional data record of the mobile banking application.

12. The method of claim 1, further comprising, in response to assigning the pending return status indicator to the transactional data record:
determining, by a content analysis engine, return policy data of a merchant associated with the transactional data record.

13. The method of claim 12, wherein determining the return policy data of the merchant associated with the transactional data record comprises:
obtaining, by the interface circuitry, a second dataset; and
parsing, by the content analysis engine, the second dataset, wherein the return policy data is determined based on the parsing.

14. The method of claim 12, wherein determining the return policy data of the merchant associated with the transactional data record comprises:
communicating, by the interface circuitry, a request to a merchant device associated with the merchant; and
receiving, by the interface circuitry, the return policy data in response to the request.

15. The method of claim 12, further comprising:
generating, by a notification engine, reminder data based on the return policy data; and
causing, by communications hardware, presentation of the reminder data at a device associated with the user via the mobile banking application.

16. The method of claim 15, further comprising:
determining, by geofence circuitry, that the device associated with the user is within a predefined proximity of a physical location associated with the merchant,
wherein causing presentation of the reminder data at the device associated with the user via the mobile banking application is performed in response to determining that the device associated with the user is within the predefined proximity of a physical location associated with the merchant.

17. The method of claim 15, wherein causing presentation of the reminder data at the device associated with the user via the mobile banking application is performed in response to determining a time threshold associated with the return policy data has been satisfied.

18. The method of claim 1, wherein reconciling the transactional data record is further based on a second transactional data record indicating a credit of a purchase amount indicated by the transactional data record.

19. An apparatus comprising:
a data modification engine configured to assign a pending return status indicator to a transactional data record of a mobile banking application, wherein the transactional data record is associated with a user;
interface circuitry configured to obtain a first dataset associated with the user; and
a transaction analysis engine configured to:
determine that the first dataset corresponds to the transactional data record, and
reconcile the transactional data record based at least on the first dataset.

20. A computer program product comprising at least one non-transitory computer-readable storage medium storing software instructions that, when executed, cause an apparatus to:
assign a pending return status indicator to a transactional data record of a mobile banking application, wherein the transactional data record is associated with a user;
obtain a first dataset associated with the user;
determine that the first dataset corresponds to the transactional data record; and
reconcile the transactional data record based at least on the first dataset.
